(19) United States
(12) Patent Application Publication
(10) Pub. No.: US 2025/0148306 A1
(43) Pub. Date: May 8, 2025

(54) OPTIMIZED CONTENT MODERATION WORKFLOW

(71) Applicant: INTERNATIONAL BUSINESS MACHINES CORPORATION, ARMONK, NY (US)

(72) Inventors: Jesus Manuel Olivera, New York, NY (US); Avery Tate, Newport, RI (US); Mahalakshmi Lakshminarayanan, Austin, TX (US)

(21) Appl. No.: 18/503,283

(22) Filed: Nov. 7, 2023

(51) Int. Cl. G06N 5/022

(52) U.S. Cl. CPC G06N 5/022

(57) ABSTRACT

A method, computer system, and a computer program product are provided for evaluating content moderation by training an Artificial Intelligence (AI) engine. A plurality of data is obtained to be used for training the AI engine. A plurality of current labels are generated using an associated category and topic. Any past labeled data similar to the plurality of data obtained is collected. It is then determined if the current labels or the past labelled data have one or more associated biases based on a bias criteria. A fairness weight score is calculated for each current label based on the associated number of biases and whether the current label is associated with any past label data with one or more biases. A final label is generated for the plurality of current labels based on the fairness weight score. The final label is used to train the AI engine.

### BACKGROUND

The present invention relates generally to the field of data management and more particularly to techniques using machine learning for providing an optimized content moderation workflow.

Online platforms are increasingly required to moderate their content in order to provide their users a safe space for their online interactions preventing and mitigating the possible risks and negative effects of bad actors. Organizations are designing, building, and deploying labeling pipelines. Many of these use Artificial Intelligence (AI) engines having one or more Machine Learning (ML) models and algorithms to train in detecting viral events that lead to spread of online threats and negative content.

An issue with many prior art currently being used, is the ability to provide content moderation without bias. Machine Learning bias and algorithm bias is a phenomenon that occurs when an algorithm produces results that are systematically affected by prejudice based on erroneous assumptions introduced during the ML learning process. This affects data integrity and the ability to create precise AI models

Consequently, it is desirous to create a transparent content moderation that removes bias. It is optimal to provide techniques that can leverage machine learning (ML) an AI engine, and human input to classify and determine relevant and bias free content. It is desirous for the technique to be applicable in a variety of platforms including on-line platforms.

### SUMMARY

Embodiments of the present invention disclose a method, computer system, and a computer program product for evaluating content moderation by training an Artificial Intelligence (AI) engine. In one embodiment, a method is provided that comprises of obtaining a plurality of data to be used for training the AI engine. A plurality of current labels are generated for the plurality of data using an associated category and a topic. Any past labeled data that is similar to the plurality of data obtained is collected. It is then determined if the current labels or the past labelled data have one or more associated biases based on a bias criteria. A fairness weight score is calculated for each current label based on the number of biases determined to be associated with the current label and whether the current label is associated with any past label data with one or more biases. An final label is generated for the plurality of current labels based on the fairness weight score and the final label is used to train the AI engine.

In another embodiment, a computer is provided for evaluating content moderation by training an Artificial Intelligence (AI) engine. The system comprises one or more processors, one or more computer-readable memories and one or more computer-readable storage media. It also comprises program instructions, stored on at least one of the one or more storage media for execution by at least one of the one or more processors via at least one of the one or more memories, to obtain a plurality of data to be used for training the AI engine. In addition, program instructions, stored on at least one of the one or more storage media for execution by at least one of the one or more processors via at least one of the one or more memories are also provided to generate a plurality of current labels for the plurality of data using an associated category and a topic. Program instructions, stored on at least one of the one or more storage media for execution by at least one of the one or more processors via at least one of the one or more memories are also provided to collect any past labeled data that is similar to the plurality of data obtained. It is then determined if the current labels or past labeled data have one or more associated biases based on a bias criteria. In addition program instructions are provided, stored on at least one of the one or more storage media for execution by at least one of the one or more processors via at least one of the one or more memories are also provided to calculate a fairness weight score for each current label based on a number of biases determined to be associated with it label and whether the current label is associated with any past label data determined to have one or more biases. An final label is generated for each plurality of current labels based on the fairness weight. The final label is used for training the AI engine.

In another embodiment, a computer program product is provided for evaluating content moderation by training an Artificial Intelligence (AI) engine. The computer program product comprises one or more computer readable storage media. It also comprises program instructions, stored on at least one of the one or more storage media for execution by at least one of the one or more processors via at least one of the one or more memories, to obtain a plurality of data to be used for training the AI engine. In addition, program instructions, stored on at least one of the one or more storage media for execution by at least one of the one or more processors via at least one of the one or more memories are also provided to generate a plurality of current labels for the plurality of data using an associated category and a topic. Program instructions, stored on at least one of the one or more storage media for execution by at least one of the one or more processors via at least one of the one or more memories are also provided to collect any past labeled data that is similar to the plurality of data obtained. It is then determined if the current labels or past labeled data have one or more associated biases based on a bias criteria. In addition program instructions are provided, stored on at least one of the one or more storage media for execution by at least one of the one or more processors via at least one of the one or more memories are also provided to calculate a fairness weight score for each current label based on a number of biases determined to be associated with it label and whether the current label is associated with any past label data determined to have one or more biases. An final label is generated for each plurality of current labels based on the fairness weight. The final label is used for training the AI engine.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 illustrates an operational flowchart for evaluating content moderation by training an Artificial Intelligence (AI) engine, according to one embodiment;

FIG. 3 provides a flow diagram of an ML pipeline using collected data, according to one embodiment; and

FIG. 4 provides block diagram of an example of a scenario using fairness categories.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In one embodiment, a computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In one embodiment, techniques are provided for evaluating content moderation by training an Artificial Intelligence (AI) engine. A plurality of data to be used for training the AI engine is obtained. Any past labeled data that is similar to the plurality of data obtained is collected. A plurality of labels are generated for the plurality of data using an associated category and a topic. The labels are analyzed for fairness and compared to the plurality of data with the past data collected for bias to provide a plurality of fairness scores. A fairness weight score is calculated for each label based on the fairness scores. An updated final label is determined for each plurality of labels based on the fairness score. An updated final label is generated for the plurality of data associated with the labels for training the AI engine. In one embodiment, the plurality of labels are measured for fairness scores by annotating a plurality of data elements associated with each label. In another embodiment, labels are identified with higher weight scores and providing more importance with data associated with them in training the AI engine. The AI engine can be self trained and trained to achieve better results, such as through iterative analysis of the updated final label. The weight scores are also updated and provided to the AI engine as new data is obtained. In addition, the fairness values are adjusted over time based on analysis of data. The AI can include one or more machine learning models and algorithms. In one embodiment, the AI engine generates a plurality of predicted outcome based on the plurality of data and the final labeling of the plurality of data modifies the predicted outcome.

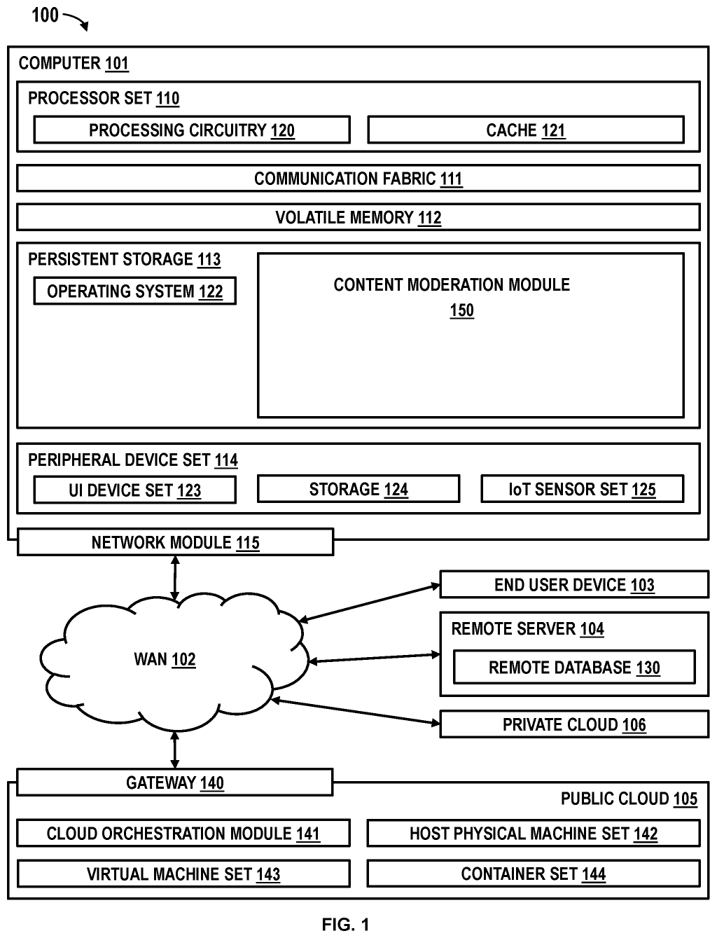

FIG. 1 provides a block diagram of a computing environment 100. The computing environment 100 contains an example of an environment for the execution of at least some of the computer code involved in performing the inventive methods, such as code change differentiator which is capable of improving data management using a content moderation module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

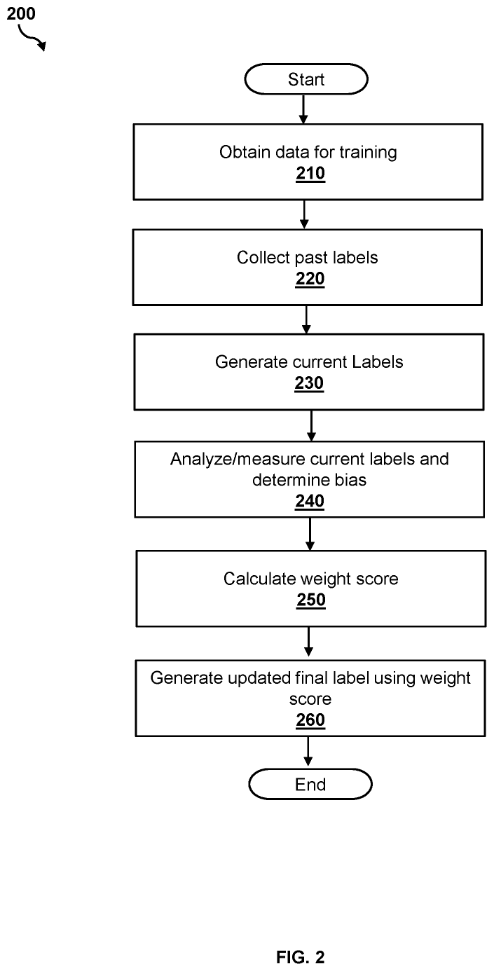

FIG. 2 is a flowchart providing an illustration of a process 200 that provides for an optimized content moderation technique. Content modulation obtains data (user generated or from other sources) and checks it against a predetermined guideline to ensure integrity. This can be used to prevent fraud or cyberattacks. It can also be used to remove bias as shown in process 200. As will be discussed, the process 200 uses ranked fairness and moderation user labeling weights to accomplish this task. Bias can stem from a variety of sources such as historical inequalities, poor metrics, human prejudices or other incorrect and erroneous assumptions. In one embodiment, an Artificial Intelligence (AI) engine using Machine Learning (ML) models can be trained and then effectively used to evaluate the process in a plurality of obtained content. The content may be placed in a pipeline. User profiles can be used for labeling data and/or for breaking ties for content with unclear labels to provide continuous training for the ML models. In this manner ML models determine how the content is or may be classified and handle the moderation within a given (online) platform. Process 200 is provided in more detail in conjunction with the process steps discussed below.

In Step 210, data is obtained using a variety of content. This data, in one embodiment can be collected using on-line sources. Obtained or collected data is then labeled to train one or more Machine Learning (ML) models. This data will be used for training the AI engine.

In Step 220, previously labeled data is analyzed to determine processing information. This data is obtained through historical means such as through data stored in a database or acquired through user or device profiles.

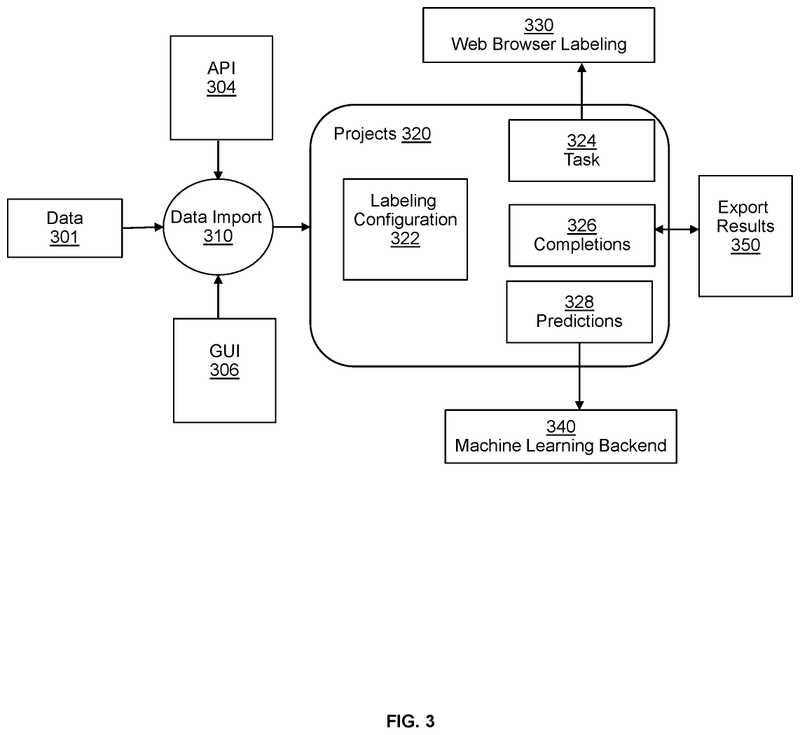

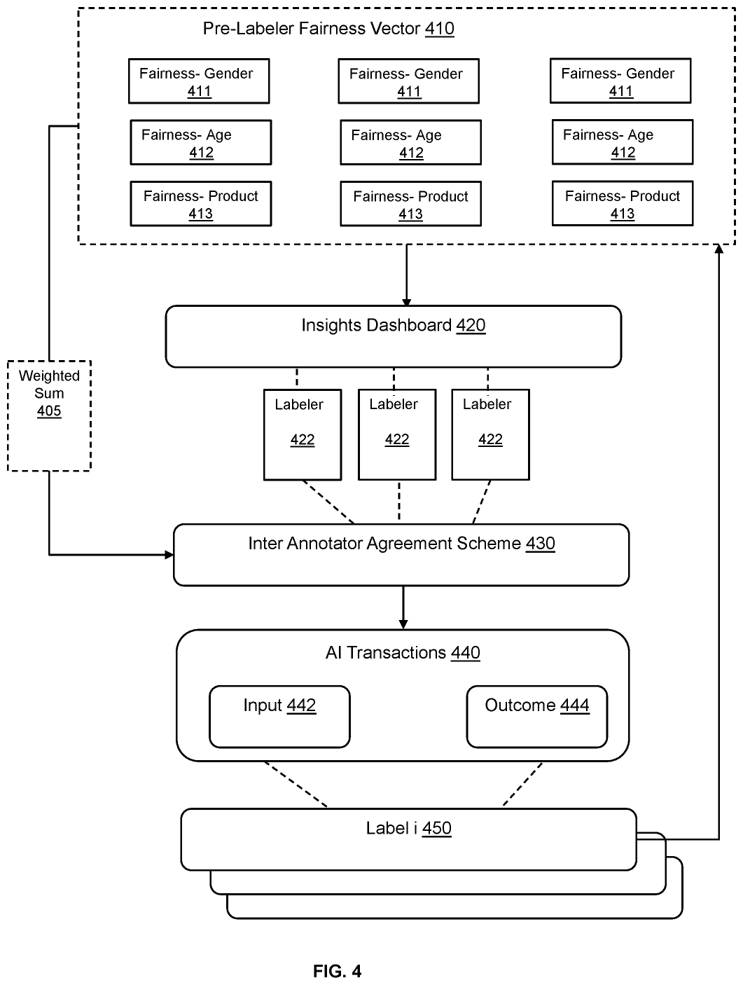

In Step 230, information gathered in Steps 210 and 220 are compiled and current labels generated. A plurality of categories and topics may be used to generate labeled data (referenced as current label). Current labels are scored a fairness score per each category. This can be discussed in more details in FIGS. 3 and 4. In one embodiment, data is annotated provides a fairness score for current labels per each of category and topic present as related to the labels (labels may have this associated with one or more elements).

In Step 240, current label is analyzed and determined if the current labels or the past labelled data have one or more associated biases based on a bias criteria.

In Step 250, for each current label it is determined if there are one or more biases and if the current label is associated with previous similar labels with one or more biases. This will provide a fairness weight score. In one embodiment, as will be discussed in more detail in FIG. 4, a weighted sum of fairness score can be used with any weighted voting scheme to provide the ranking. A decision matrix (Pugh matrix) can also be leveraged.

In Step 260, a final label is generated using the weight scores. In one embodiment, based on the weighted fairness scores, identifying fairer labelers and placing a greater weight on the fairer labelers input when determining a final label for the data.

The process can be reiterated as shown by the arrows. Reiterating the process will help training the ML model so that an optimized result can be achieved. In addition, this will allow, in one embodiment for an increasing transparency regarding content moderation decisions and removing bias and providing a repeatable framework for content moderation. The process 200 can use ML self-correcting models. This is due to the fact that in one embodiment, the labeler is able to vote on anything. Learning can be achieved through reiteration as well. The more the process is reiterated, the more fair that user becomes, the more their vote counts over time relative to the other voters. In this way, over time all bias and prejudice is removed.

In this way, the process 200 as discussed, is used for evaluating content moderation by training an Artificial Intelligence (AI) engine. To summarize, the methodology shown obtains a plurality of data to be used for training the AI engine. A plurality of current labels are generated for the plurality of data using an associated category and a topic. Any past labeled data that is similar to the plurality of data obtained is collected. It is then determined if the current labels or the past labelled data have one or more associated biases based on a bias criteria. A fairness weight score is calculated for each current label based on the number of biases determined to be associated with the current label and whether the current label is associated with any past label data with one or more biases. An final label is generated for the plurality of current labels based on the fairness weight score and the final label is used to train the AI engine.

In this way, the process 200 can be used to leverage machine learning (ML) through training to evaluate content moderation evaluation pipelines, which leads to improved quality of prediction overtime. The ML models are trained to moderate content by evaluating fairness of datasets (users) or break ties in cases where labels are unclear and providing higher weightage to the users with higher rankings of fairness so the users with the higher rankings have a greater influence on a final label for a particular data element.

In one embodiment, process 200 removes the necessity and current prior art practice of having labelers always label the things they are given, for example, as they grab items from a queue. There is no need for filtering either (related to “who gets what” item per se.) In most circumstances, over time, each existing log (of choices) gets evaluated for fairness×N for N topics. Each topic has its own definition of what fair is, and anything is supported. The fairness outcomes for each user may be utilized in the final adjudication of what a label should be (i.e. it becomes part of the weighted sum or whatever mechanism is used to weigh a labeler's output). The system is unaware that this is happening and therefore a seamless and transparent process is created.

FIG. 3 provides a flow diagram of the process 200 as applied to a machine language pipeline. As discussed in FIG. 2, at Step 210, data 310 is obtained using a variety of content. This data 310 can be direct input as shown in 301 or can be collected through a variety of sources (shown as API 304 and GUI 306) or be gathered even using on-line sources. Obtained or collected data is then labeled to train one or more Machine Learning (ML) models as shown at 340. Information gathered is compiled as shown at 320 which can include Labeling configuration 322 and categorizing it through for each labeler per category and topic (324 and 326 for example) and for the labelers prediction (328). In one embodiment, previously labeled data 330 is analyzed to determine processing information. This data is obtained through historical means such as through data stored in a database or acquired through user or device profiles. Results are then exported at 350 as needed to users and consumers (as well as for training 340).

FIG. 4 provides an example of a scenario using the process 200 as discussed in FIG. 2. Fairness categories 411, 412 and 413 are examined in a pre-labeler fairness process and a related vector provided. Data is compiled and a plurality of categories are established through Labeled data (through insights dashboard 420). Labelers 422 are scored a fairness score per each category and a fairness score is calculated through a weighted sum process 405. In one embodiment, as discussed a weighted sum of fairness score can be used with any weighted voting scheme to provide the ranking. A decision matrix (Pugh matrix) can also be leveraged. This allows the agreement scheme 430 to provide fairness scores (as weighted) for each labeler per category and topic against the labelers prediction. In this way the labelers fairness is calculated when annotating data elements (based on any of the available methods used to calculate fairness). Each of the labelers will have a fairness score per each of the categories/topics present in each data element they are annotating. Those labeler scores per category/topic will be weighed against their prediction so more fair labelers input influence the final label with a greater weight. As shown, the Labelers 422 don't have access to the insights dashboard 420 compiling their fairness scores per each category/topic. Overtime, as labelers become “more” fair (See 450 that is reiteratively used), the weights of their labels increase. All the process is automated since the method compiles, analyses labels and compute fairness scores as they are produced by the labelers. This is done through the AI trainings 440 (input provided 442 and outcome 444 is used for further learning).

The embodiments as discussed in FIG. 2-4 increases transparency regarding content moderation decisions, removes bias and provides a repeatable framework for content moderation. The process focuses on improving quality of predictions by improving the human training dataset labeling process. It also improves the quality of the prediction of ML models moderating content by evaluating fairness of the users that label training datasets or break ties in cases were the labels are unclear by providing higher weightage to the users with higher rankings of fairness so those users with higher rankings can determine the final label for a particular data element.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for evaluating content moderation by training an Artificial Intelligence (AI) engine, comprising:
obtaining a plurality of data to be used for training said AI engine;
generating a plurality of current labels for said plurality of data using an associated category and a topic;
collecting any past labeled data that is similar to said plurality of current labels;
determining if said current labels or said past labeled data have one or more associated biases, wherein said one or more associated biases are based on a bias criteria;
calculating a fairness weight score for each current label based on a number of biases determined to be associated with said current label and whether said current label is associated with any past label data determined to have one or more biases;
generating a final label for each plurality of current labels based on said fairness weight score; and
using said final label for training said AI engine.

2. The method of claim 1, wherein said fairness weight score with one or more bias are a fraction of fairness weight scores with no bias.

3. The method of claim 1, wherein each current label has a plurality of data elements.

4. The method of claim 2, wherein said updated final label is iteratively analyzed and said weight scores are updated and provided to said AI engine as new data is obtained.

5. The method of claim 1, wherein fairness weight scores are adjusted over time based on analysis of data.

6. The method of claim 2, wherein said AI engine has one or more machine language models.

7. The method of claim 1, wherein said AI engine generates a plurality of predicted outcome and updaters and modifies said predicted outcome based on said final label.

8. A computer system for evaluating content moderation by training an Artificial Intelligence (AI) engine, comprising:
one or more processors, one or more computer-readable memories and one or more computer-readable storage media;
program instructions, stored on at least one of the one or more storage media for execution by at least one of the one or more processors via at least one of the one or more memories, to obtain a plurality of data to be used for training said AI engine;
program instructions, stored on at least one of the one or more storage media for execution by at least one of the one or more processors via at least one of the one or more memories, to generate a plurality of current labels for said plurality of data using an associated category and a topic;
program instructions, stored on at least one of the one or more storage media for execution by at least one of the one or more processors via at least one of the one or more memories, to collect any past labeled data that is similar to said plurality of current labels;
program instructions, stored on at least one of the one or more storage media for execution by at least one of the one or more processors via at least one of the one or more memories, to determine if said current labels or said past labeled data have one or more associated biases, wherein said one or more associated biases are based on a bias criteria;
program instructions, stored on at least one of the one or more storage media for execution by at least one of the one or more processors via at least one of the one or more memories, to calculate a fairness weight score for each current label based on a number of biases determined to be associated with said current label and whether said current label is associated with any past label data determined to have one or more biases;
program instructions, stored on at least one of the one or more storage media for execution by at least one of the one or more processors via at least one of the one or more memories, to generate a final label for each plurality of current labels based on said fairness score; and
program instructions, stored on at least one of the one or more storage media for execution by at least one of the one or more processors via at least one of the one or more memories, to use said final label for training said AI engine.

9. The computer system of claim 8, wherein said fairness weight score with one or more bias are a fraction of fairness weight scores with no bias.

10. The computer system of claim 8, wherein each current label has a plurality of data elements.

11. The computer system of claim 8, wherein each current label has a plurality of data elements.

12. The computer system of claim 9, wherein said updated final label is iteratively analyzed and said weight scores are updated and provided to said AI engine as new data is obtained.

13. The computer system of claim 8, wherein said wherein fairness weight scores are adjusted over time based on analysis of data.

14. The computer system of claim 8, wherein said AI engine generates a plurality of predicted outcome and updaters and modifies said predicted outcome based on said final label.

15. A computer program product for evaluating content moderation by training an Artificial Intelligence (AI) engine comprising:
one or more computer readable storage media;
program instructions, stored on at least one of the one or more storage media for execution by at least one of the one or more processors via at least one of the one or more memories, to obtain a plurality of data to be used for training said AI engine;
program instructions, stored on at least one of the one or more storage media for execution by at least one of the one or more processors via at least one of the one or more memories, to generate a plurality of current labels for said plurality of data using an associated category and a topic;
program instructions, stored on at least one of the one or more storage media for execution by at least one of the one or more processors via at least one of the one or more memories, to collect any past labeled data that is similar to said plurality of current labels;
program instructions, stored on at least one of the one or more storage media for execution by at least one of the one or more processors via at least one of the one or more memories, to determine if said current labels or said past labeled data have one or more associated biases, wherein said one or more associated biases are based on a bias criteria;
program instructions, stored on at least one of the one or more storage media for execution by at least one of the one or more processors via at least one of the one or more memories, to calculate a fairness weight score for each current label based on a number of biases determined to be associated with said current label and whether said current label is associated with any past label data determined to have one or more biases;
program instructions, stored on at least one of the one or more storage media for execution by at least one of the one or more processors via at least one of the one or more memories, to generate a final label for each plurality of current labels based on said fairness score; and
program instructions, stored on at least one of the one or more storage media for execution by at least one of the one or more processors via at least one of the one or more memories, to use said final label for training said AI engine.

16. The computer program product of claim 15, wherein said fairness weight score with one or more bias are a fraction of fairness weight scores with no bias.

17. The computer program product of claim 15, wherein each current label has a plurality of data elements.

18. The computer program product of claim 16, wherein said updated final label is iteratively analyzed and said weight scores are updated and provided to said AI engine as new data is obtained.

19. The computer program product of claim 15, wherein fairness weight scores are adjusted over time based on analysis of data.

20. The computer program product of claim 15, wherein said AI engine has one or more machine language models.
